(19) United States
(12) Patent Application Publication
(10) Pub. No.: US 2008/0197155 A1
(43) Pub. Date: Aug. 21, 2008

(54) Structure of a glue gun

(76) Inventor: Chen Chien Liang, (US)

Correspondence Address: Liberty PTO, P.O. Box 590, Taichung, 400, omitted

(21) Appl. No.: 11/707,907

(22) Filed: Feb. 20, 2007

(51) Int. Cl. G01F 11/00

(52) U.S. Cl. 222/391

(57) ABSTRACT

The invention relates to a structure of a glue gun, having a back cap disposed at the rear side of a containing body for glue tube, a grip with leveler connected to the outside of the containing body, at the top of the grip and leveler disposed a central rod penetrating through the back cap to the glue tube body. The tip of central rod having a pushing plate for pushing out glue of a glue tube, the central rod is provided a compressed spring, a pushing plate, a returnable spring and a control sheet through the leveler and the top of grip to enable the central rod by movement of the leveler to drive the pushing plate so that the central rod moves forward pushing the back cap of the glue tube by driving the pushing plate allowing the glue inside the glue tube to flow though a front drawing tube of the front side of the tube body; wherein the through-hole in the center of the pushing plate provided by the central rod passes through, and the edge of the hole on two sides form a oblique round edge from the outside to the through-hole so that the circumferential edge inside the oblique round edge and the interior wall of the through-hole connects smoothly without sharp edges that prevent the brake from the pushing plate wearing the exterior wall of the central rod and thus allowing smooth movement of the central rod.

### FIELD OF THE INVENTION

This invention relates to a structure of a glue gun and more particularly to a unique structure of the pushing plate of the glue gun that prevents the brake of the pushing plate rubbing the exterior wall of the central rod to aid smooth movement of the central rod.

### BACKGROUND OF THE INVENTION

Please refer to FIGS. 1, 2 and 3, of prior art. Leveler 13 is pushed inwardly to drive the bottom of pushing plate 19 to move ahead obliquely and act as a brake for the central rod 15 to control its movement. Leveler 13 cannot return due to the control sheet 21, which normally enables the bottom of the control sheet 21 to move obliquely and fasten the central rod 15 by the elastic extension from the returnable spring 20. Therefore the repeated inwards push from the leveler 13 to drive the pushing plate 19 to connect and drive the central rod 15 to move forwards enables the tipcentral rod 15 to extract the glue body 10 and then the glue flows from the front drawing tube 22 of the front side of tube body 11. It is easy to see the disadvantages that need to be improved due to an imperfect structure of a glue gun of the prior art:
1. The center of pushing plate 19 is provided by directly opening the hole 41, and installing the central rod 15 through it. Therefore a sharp edge 42 is formed between the jointed place edges of the holes of two sides of through-hole 41 and the interior wall of the through-hole 41. When the pushing plate 19 is moved obliquely to brake the central rod 15 forwardly by the movement of the leveler 13, the sharp edge 42 is very easy to press the exterior wall of the central rod 15 to form a hollow trough 16, which results in wear to the exterior wall of the central rod 15.
2. Because the exterior wall of the central rod 15 is very easy to be pressed by sharp edge 42 of the pushing plate 19 to form many hollow troughs 16. The exterior wall of central rod 15 can't retain its flatness. When central rod 15 keeps moving forward, multiple troughs 16 forming on the exterior wall will obstruct and rub with the control sheet 21 and results the central rod 15 being unable to move forward smoothly, wearing the control sheet 21.

### SUMMARY OF THE INVENTION

In view of above, the inventor focused on the above disadvantages by detailed design and evaluation based on manufacturing, development and design experience of many years to obtain a useful invention.

The primary purpose of the invention is to provide a structure of a glue gun, which prevents the brake of the pushing plate from wearing the exterior wall of the central rod by the unique power of the pushing plate of the glue gun and further achieving a useful purpose to enable the smooth movement of the central rod.

To enable the examiner to further understand and realize the purpose, technique characteristic and benefit of the present invention, the drawings are accompanied with the following detailed specification.

### DETAILED DESCRIPTION OF PREFERRED EMBODIMENTS

Referring to FIGS. 4, 5 and 6. The present invention provides a structure of a glue gun having a back cap 12 disposed on the rear side of a tube body 11 containing a glue tube 10. A grip 14 with leveler 13 is connected to its outer side, the grip 14 and top of the leveler 13 is provided with a central rod 15 horizontally through the back cap 12 into the tube body 11. The tip of central rod 15 is provided a pushing plate 17 to push the back cap of the glue tube 10 and the central rod 15 is provided a compressed spring 18, a pushing plate 19, a returnable spring 20 and a control sheet 21 through the leveler 13 and the top of grip 14 to enable the central rod 15 by movement of the leveler 13 to drive the pushing plate 19 so that the central rod 15 moves forward to push the back cap of the glue tube 10 by driving the pushing plate 17, and then the glue stick inside the glue tube 10 can be conduct by a front drawing tube 22 of a tip of the tube body 11, wherein said tube body 11 has a through-hole 41 in the center of the pushing plate 19 with the central rod 15 passing through, its edge of the hole of two sides forming an oblique round edge 30 from the outside of the through-hole 41 so that the circumferential edge inside the oblique round edge 30 and the interior wall of the through-hole 41 can connect smoothly without any sharp edge formed that prevents the brake of the pushing plate 19 abrades the exterior wall of the central rod 15 to allow smooth movement of the central rod 15.

The above describes the relevant structure, characteristics and assembly of the present invention in detail. It's believable that the examiner has known the present invention to a certain level. To accentuate the purpose, characteristic and benefits of the present invention, the following describes its usage condition, expected benefits and advantages.

Please refer to FIGS. 4, 5 and 6. The two sides of the central through-hole 41 of the pushing plate 19 of the present invention forms an oblique round edge 30 without sharp edges and connecting to the interior wall of the through-hole 41 smoothly so that when pushing plate 19 is move obliquely to brake the central rod 15 when moving forward, there are no sharp edges formed in the two sides of through-hole 41 of the pushing plate 19 and it won't press the exterior wall of the central rod 15 producing hollow troughs. Therefore the exterior wall of the central rod 15 is hard to wear and does not produce rough surfaces and further allows smoother movement of the central rod 15, the control sheet 21 and the pushing plate 19, offering the best user benefit.

As described above, the structure of a glue gun provided by the present invention indeed fulfills all the purposes of the present invention and the arrangement of its assembled structure has never been seen in products of the same field, and has never been published before the application, which meets the requirements of patent laws and therefore is submitted herein.

### BRIEF DESCRIPTION OF THE DRAWINGS

FIG. 1 is a diagram shows the three-dimensional appearance of the assembly of a prior glue gun.

FIG. 2 is a diagram shows the plane of the pushing plate of the prior glue gun.

FIG. 3 is a diagram shows the cross-section of the pushing plate of the prior glue gun.

FIG. 4 is a diagram shows the three-dimensional appearance of the assembly of the present invention.

FIG. 5 is a diagram shows the three-dimensional appearance of the pushing plate of the present invention.

FIG. 6 is a diagram shows the cross-section of the pushing plate of the present invention.

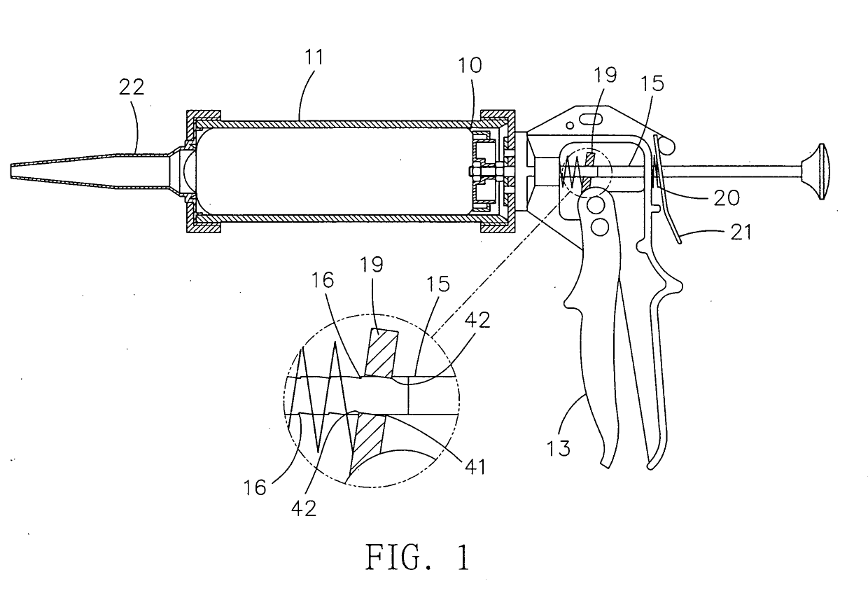

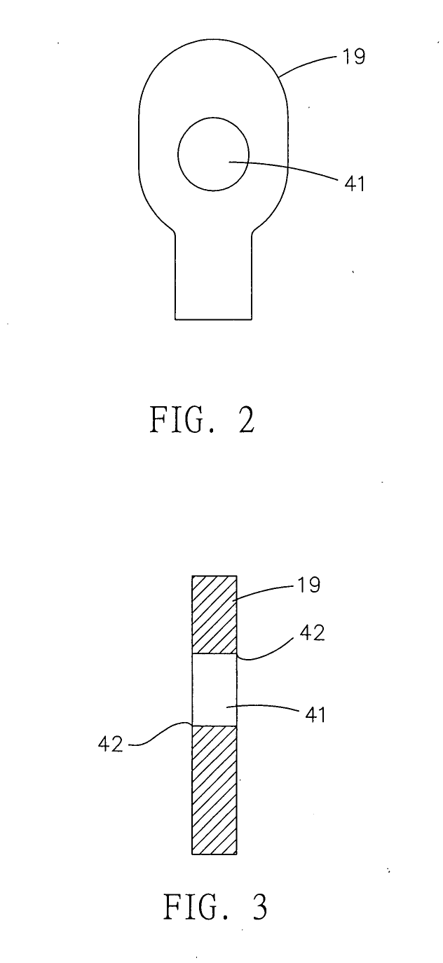

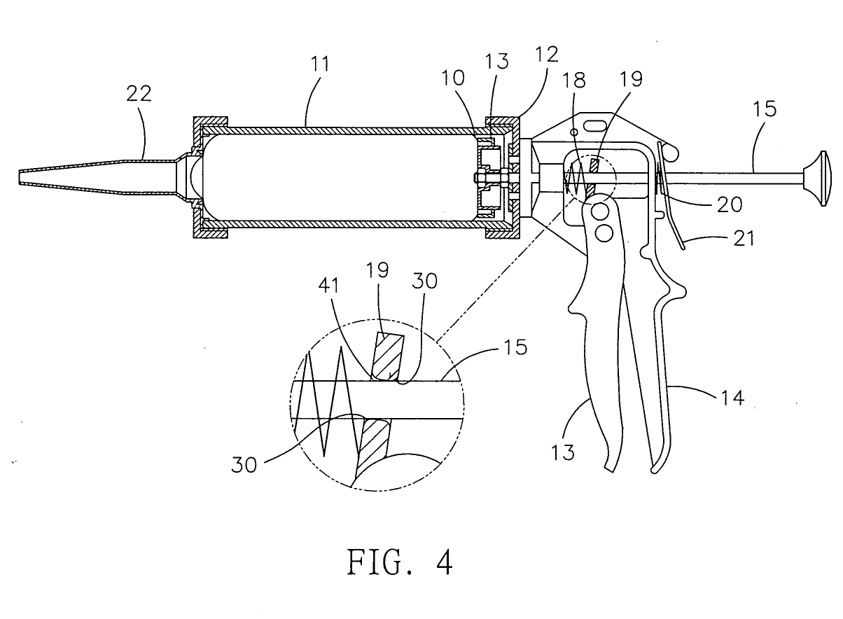

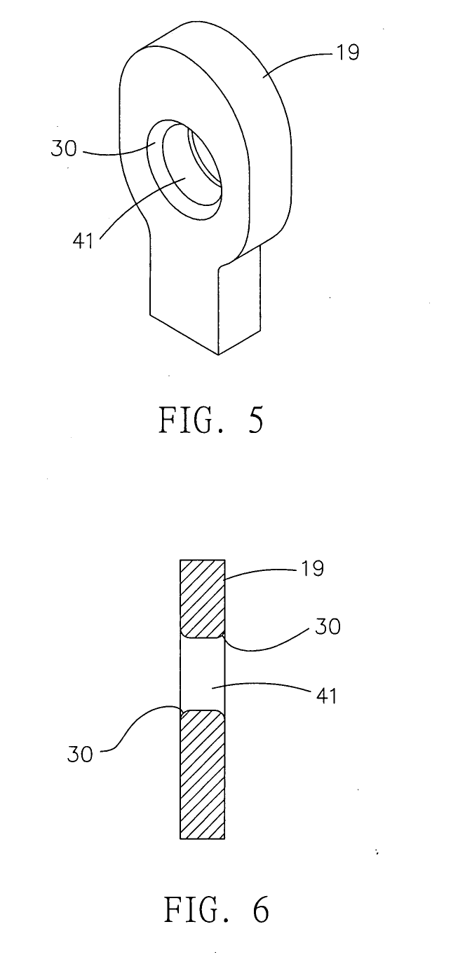

1. A structure of a glue gun, having a back cap disposed on the rear side of a tube body
containing a glue tube, a grip with leveler is connected to its outer side. The grip and top of the leveler is provided on the central rod horizontally through the back cap into the tube body. The tip of the central rod provides a proceeding sheet to push the back cap of the glue tube, with the central rod having a compressed spring, a pushing plate, a returnable spring and a control sheet through the leveler and at the top of the grip to enable the central rod by movement of the leveler to drive the pushing plate so that the central rod moves forward pushing the back cap of the glue tube by driving the proceeding sheet. The glue inside the glue tube can be conduct by a front drawing tube of a front side of the tube body, wherein the through-hole in the center of the proceeding sheet provided by the central rod passes through. The edges of the hole of two sides form an oblique round edge from the outside of the through-hole so that the circumferential edge inside the oblique round edge and the interior wall of the through-hole can be connected smoothly without sharp edges forming, and thus preventing the brake of the pushing plate rubbing and wearing the exterior wall of the central rod to allow smooth movement of the central rod.
